(19) United States
(12) Patent Application Publication
(10) Pub. No.: US 2004/0078242 A1
(43) Pub. Date: Apr. 22, 2004

(54) Method of administering life settlement insurance program

(76) Inventors: Sanford B. Weiss, Los Angeles, CA (US); Bruce Rosenfeld, Beverly Hills, CA (US); John Fischer, Philadelphia, PA (US)

Correspondence Address: Bruce B. Brunda, STETINA BRUNDA GARRED & BRUCKER, Suite 250, 75 Enterprise, Aliso Viejo, CA, 92656, US

(21) Appl. No.: 10/163,131

(22) Filed: Jun. 4, 2002

(51) Int. Cl. G06F 17/60

(52) U.S. Cl. 705/4

(57) ABSTRACT

A life settlement insurance program is provided including an insured having a life insurance policy and a predetermined life expectancy. A contracting entity is provided for contracting for the assignment of the insured's life insurance policy benefits to a designated beneficiary in exchange for payment to the insured. In the present invention the contracting entity is a non-profit entity. The designated beneficiary may be the non-profit contracting entity, or a service provider, under a contract to provide services to the insured.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention is directed to a method of administrating a life settlement insurance program. More specifically, the invention is directed to a methodology for enhancing payments to insureds in exchange for assignment of life insurance policies, during the life of the insured.

Traditional life insurance policies result in a payment upon the death of the insured. During his or her life the insured may designate one or more beneficiaries to receive the proceeds of the insurance policy upon death of the insured.

While such conventional insurance policies are useful, and may be effective ways of accumulating and transferring wealth to beneficiaries, such transfer cannot take place until death occurs. In some cases the insured, or the beneficiaries, may develop an immediate need for funds to support requirements that could be satisfied or mitigated by immediate access to insurance proceeds. For example, an insured may become ill and need funds to pay for long term health care to allow him to live his remaining days in comfort and dignity. In such cases an insured might prefer immediate access to policy proceeds for his own use, rather than transfer those proceeds to others after his death. Similarly, an insured may desire to transfer proceeds from the insurance policy to beneficiaries for their use prior to his death, e.g., to help the beneficiaries to purchase a home or start a business. In such cases the present value of the insurance proceeds may be more useful than the future value of those proceeds.

Certain types of insurance products allow an insured to obtain a cash value of the policy, as determined by the insurance carrier. In other cases an insured may take loans against an insurance policy. However, the cash value and loan basis for such insurance policies is frequently quite limited.

More recently certain insurance providers have begun to offer life settlement insurance programs. “Life settlements” is a term applied to payments made to the insured, during the life of the insured, in exchange for assignment of the insurance policy proceeds upon the death of the insured. Such policies have been utilized by persons with AIDS or other terminal illnesses, who desire to access insurance proceeds to assist in their immediate medical needs.

The payments made under life settlement policies are frequently limited, commonly in the range of fifty percent of the policy death benefit. Moreover, insurers frequently limit the availability of life settlement policies to only those individuals whose life expectancy is three years or less. Specific life settlement proceeds may be determined by a medical evaluation of the condition of the insured and other relevant factors. From the insurance carrier standpoint, profitability of life settlement policies is enhanced by mitigating the payment to the insured, and reducing risk by limiting the availability of the policy to those whose life expectancy is short term, e.g., three years or less. Insurance carriers are also acutely aware that medical advances have been effective to significantly extend the life of individuals having terminal conditions. While those advances are certainly welcome by affected individuals, the resulting increase in life expectancy may make those individuals ineligible to receive life settlements under conventional insurance carrier criteria intended to enhance short term profitability and mitigate risk to the carrier.

Accordingly, there is a need to develop a restructured business model for offering life settlement policies to insureds. In particular, there is a need to enhance payouts available to insureds, and to make payouts available to individuals having longer life expectancies. The present invention is directed to providing these and other benefits in connection with life settlement policies for insureds.

### BRIEF SUMMARY OF THE INVENTION

A life settlement insurance program is provided including an insured having a life insurance policy and a predetermined life expectancy. A contracting entity is provided for contracting for the assignment of the insured's life insurance policy benefits to a designated beneficiary in exchange for payment to the insured. In the present invention the contracting entity is a non-profit entity under applicable tax codes. The designated beneficiary may be the non-profit contracting entity, or a service provider, under a contract to provide services to the insured. A funding source is provided for advancing funds to the contracting entity sufficient to make life settlement payments to the insured. The funding source may be an organization such as AARP or The American Cancer Society, which may have a significant interest in maximizing settlement payments to the insured.

Depending on the jurisdiction and current tax provisions within the jurisdiction, the non-profit status of the contracting entity will be effective to generate tax deductions for the insured and/or the funding source.

The non-profit status of the contracting entity removes profit motivation from the contracting entity thereby enhancing funds available for life settlement payment to the insured, or for return on investment to the funding source.

Alternatively, the non-profit status of the contracting entity may be useful to enhance the availability of the life settlement payments to insureds having a longer life expectancy, e.g. 5-7 years.

The non-profit contracting entity is positioned to negotiate lower rates for long term health care services, for the benefit of the insured. The long term health care provider and funding source will therefore each have self interests in facilitating referrals of insureds to the non-profit contracting entity. Periodic profits generated by the non-profit contracting entity may be contributed to charitable organizations, thereby further enhancing the referral base for the program.

### BRIEF DESCRIPTION OF THE DRAWINGS

These as well as other features of the present invention will become more apparent upon reference to the drawings wherein:

FIG. 1 is a block diagram illustrating an exemplary embodiment of the present invention.

### DETAILED DESCRIPTION OF THE INVENTION

The present invention is described in relation to the presently preferred implementation, as set forth below. However, it is to be understood that the described implementation is exemplary, and is not intended to be the only implementation of the present invention. As will be recognized by those skilled in the field, system level implementation of the plan may be modified by rearrangement or redistribution of component features or elements of the invention. Moreover, the individual component elements may be modified by substitution of equivalent components intended to provide the same, or equivalent results. Accordingly, the described implementation is not intended to be limiting of the broader aspects of the invention.

Principal components of a contemporary life settlement program include the insured's life insurance policy, an evaluation of the insured's life expectancy, a contracting entity to negotiate and execute an agreement with the insured, an entity for marketing life settlement policies and funding sources for advancing funds sufficient to make settlement payments to the insured. In conventional business models the contracting, marketing and funding entities may be the insurance carrier. The insurance carrier is motivated to provide a significant rate of return on such funds, preferably in as short a term as practical. The profit incentive in relation to each of those activities mitigates the settlement payout available to insureds. Moreover, insofar as competition is typically limited to competing insurance carriers, there is little incentive to significantly depart from high profit business models.

In accordance with the present invention the contracting entity is preferably implemented as a non-profit entity, whose principal purpose is to enhance settlement payouts for the benefit of insureds. This significantly mitigates profit and expense associated with the business model, thereby enhancing settlement proceeds available to insureds. For example, commissions normally associated with issuance of policies are mitigated and the more charitable nature of the life settlement program is useful to attract referral or funding sources that might otherwise be commissioned, or require higher rates of return on investments.

Organizations such as teacher's unions, retirement associations and the like may recognize that the present invention offers significant advantages to their members in the form of enhanced life settlement payments and enhanced options for quality medical care. As a result, those organizations may be motivated to support the program by investing funds into the program, even if the rate of return might be somewhat less than would otherwise be available for such investments. Similarly, referrals of insureds from nursing homes, retirement organizations and other persons may be enhanced by a recognition that such referrals work to the significant benefit of their members or patients, whose welfare is in their own interest. As such, certain synergistic benefits may arise from the utilization and support of the proposed life settlement program, which benefit not only the insured, but those service and funding providers who facilitate or contribute to operation of the program.

For example, because the present invention enhances payouts to insureds, an insured may be able to secure additional health care services, or secure the same services for a longer period of time. This not only benefits the insured, but also benefits health care providers with whom the insured may contract for services. Membership associations, such as the American Association of Retired Persons (AARP) or the American Cancer Society, which are dedicated to advancing the interests of their members, may also identify significant self interests in referring members, or investing funds in the operation of the program.

Another advantageous feature of the invention concerns the charitable distribution of any incidental profits derived by the non-profit contracting entity. Such incidental profits may periodically arise as a result of differences between working capital secured from funding sources and life settlement payouts. While the general intention of the invention is to maximize distribution of settlement proceeds without profit motive, it is expected that the non-profit entity may periodically generate surplus funds, where incoming capital exceeds outgoing payouts. In such cases it is anticipated that the non-profit entity may contribute such funds to worthy causes, such as the American Cancer Society or the like. Again, the support from the non-profit entity provides further incentive for beneficiary organizations to invest operating funds in the life settlement program, and to refer insureds to the program. This further synergism enhances the vitality of the program as well as the availability of additional benefits to insureds and organizations of which they are members.

Though not essential to the business model of the present invention, it is anticipated that other benefits, including tax advantages, may derive from the present invention. For example, funding sources may identify tax advantages associated with contributing operating funds to the non-profit entity. As a result, the net rate of return to funding sources may be as good or better than the rate of return available from other similar investments. Insureds may similarly realize tax benefits by assignment of insurance policies to the non-profit entity, effectively enhancing the net value of participation in the program to the insured.

Insofar as tax advantages are dependent upon the particular circumstances of the insureds, the current status of applicable provisions of the tax codes and other features, the availability of such advantages is not certain. However, it is anticipated that such additional tax benefits may be a further advantageous feature of the invention under appropriate circumstances.

Another feature of the invention concerns the utilization of reinsurance as a means to provide further security to funding sources. Reinsurance may be obtained to generate funds to compensate funding sources in the event that the insured survives beyond a predicted life expectancy. In such case reinsurance will provide payments for distribution to funding sources to enhance the security of their investment in the life settlement program. While the cost of such reinsurance my mitigate the payouts available to insureds, or the rate of returns available to funding sources, it is not anticipated to significantly reduce the above-mentioned beneficial aspects of the present invention. Moreover, the security derived from such reinsurance may enhance the attractiveness of the invention, decreasing the rate of return necessary to attract funding sources.

It is also anticipated that funding sources for the present invention may include London Interbank Offered Rate(LIBOR)based loans. LIBOR loan rates are typically quoted each day by financial publications, and by major banks. LIBOR based loans are commonly computed on a 30-day rate, comparable to the rate that most creditworthy international banks dealing in dollars charge each other for large loans. In some cases LIBOR based loans include a premium. However, such loans may nonetheless be less expensive than borrowing at prime rate.

Yet another feature of the present invention is directed to life settlement payout options including long term care services. As such, the insured may elect to receive his or her payout partially or wholly in the form of long term care services for the insured. As presently anticipated the non-profit contracting entity could negotiate favorable long term care rates with nursing homes or other service providers. The life settlement payment to the insured could therefore be wholly or partially in the form of long term care services, for the remaining life of the insured, or for a specified term. To the extent that the life settlement payment exceeds the cost of such long term care services, the insured could receive the remaining life settlement payment in the form of a cash payment. In view of the potential for substantial referrals of insureds to long term service providers, the non-profit contracting entity could negotiate favorable rates from long term service providers, for the benefit of the insured. In one implementation of the present invention the non-profit contracting entity could itself operate the long term care provider services.

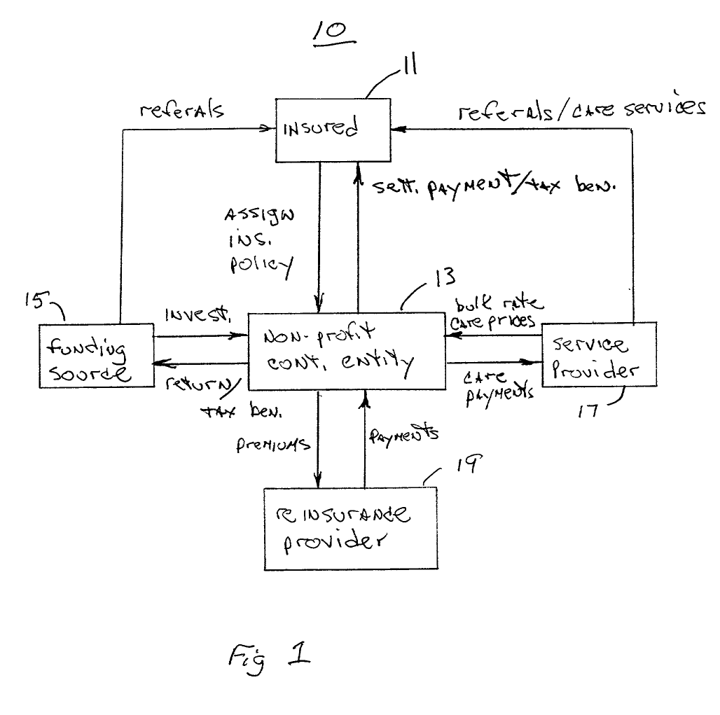

A flow chart illustrating the principal aspects of the present invention is set forth in accompanying FIG. 1. Set forth at FIG. 1 is a exemplary life settlement program 10 in accordance with the present invention. As illustrated therein the insured 11 contracts with the non-profit contracting entity 13 for assignment of the insured's life insurance policy to a designated beneficiary, such as the non-profit contracting entity 13 or service provider 17, in exchange for a settlement payment and/or long term care services. As noted above, the insured may also benefit by tax advantages associated with assigning the insurance policy to the non-profit contracting entity 13.

Funding source 15 invests funds in the non-profit contracting entity 13 sufficient to support settlement payments to the insured 11. In return, the non-profit contracting entity 13 provides the funding source 15 with the return on its investment. As noted above, the funding source may also realize certain tax benefits associated with investing funds in the non-profit contracting entity 13.

The non-profit contracting entity 13 may also contract with service provider 17 for long term care services for the benefit of the insured. Such long term care services may be offered by the service provider 17 at bulk rates favorable to the insured 11. The service provider 17 may also be motivated to provide referrals of insureds to the non-profit contracting entity 13. Funding source 15 may similarly be motivated to generate referrals, e.g. of its members, to the non-profit contracting entity 13.

Insurance(reinsurance) provider 19 may contract with the non-profit contracting entity 13 to generate a payment to non-profit contracting entity 13 upon conclusion of the predicted life expectancy of the insured. Such payments may then be provided to funding source 15, to insure that funding source 15 receives anticipated return on investment even if the insured lives beyond his predicted life expectancy.

As it will be apparent to those skilled in the field, the life settlement program 10 provides certain synergistic benefits that are not commonly associated with conventional life settlement programs. Moreover, the benefits associated with the present invention may be realized not withstanding the redistribution of the component features or elements of the invention. As such, illustrated embodiment is intended to be exemplary and not limiting in relation to the broader aspects of the invention.

What is claimed is:

1. In a life settlement insurance program including an insured have an insured's life insurance policy and a pre-determined life expectancy, a contracting entity for contracting for the assignment of the insured's life insurance policy benefits to a designated beneficiary in exchange for a payment to the insured, wherein the contracting entity is a non-profit entity.

2. The program as recited in claim 1 further including a funding source for advancing funds to the contracting entity sufficient to make life settlement payments to the insured, wherein the funding source has a substantial interest in maximizing settlement payments to the insured.

3. The program as recited in claim 2 wherein the contracting entity is an entity recognized as a non-profit entity under applicable tax codes.

4. The program as recited in claim 1 wherein the non-profit status of the contracting entity mitigates contracting entity distributions, and enhances funds available for life settlement payment to the insured.

5. The program as recited in claim 2 wherein the non-profit status of the contracting entity mitigates contracting entity distributions, and enhances funds available for financial return to the funding source.

6. The program as recited in claim 1 wherein assignment of the life insurance policy proceeds to the non-profit contracting entity is effective to generate tax deductions for the insured.

7. The program as recited in claim 2 wherein the provision of funds by the funding source to the non-profit contracting entity is effective to generate tax deductions for the funding source.

8. The program as recited in claim 1 wherein the designated beneficiary is the non profit contracting entity.

9. The program as recited in claim 1 wherein the designated beneficiary is a health care provider that provides health services to the insured.
